(19) United States
(12) Patent Application Publication
(10) Pub. No.: US 2024/0220953 A1
(43) Pub. Date: Jul. 4, 2024

(54) HYBRID ASSET MANAGEMENT SYSTEM

(71) Applicant: eBay Inc., San Jose, CA (US)

(72) Inventors: Tsun Kwan Donald SIU, Fremont, CA (US); Krithika SAIRAM, Sunnyvale, CA (US)

(21) Appl. No.: 18/148,896

(22) Filed: Dec. 30, 2022

(51) Int. Cl. G06Q 20/12; G06Q 20/36; G06Q 20/38; G06Q 30/0601

(52) U.S. Cl. CPC G06Q 20/1235; G06Q 20/3678; G06Q 20/389; G06Q 30/0631; G06Q 2220/00

(57) ABSTRACT

Methods, systems, and computer storage media for providing a hybrid asset management service for physical assets and digital assets. The hybrid asset management service includes interface elements and asset management operations for combined management of physical assets and digital assets. In operation, a request to perform a hybrid asset management operation for a digital asset is received. Based on the request, digital asset listing data of the digital asset is accessed. A physical asset associated with the digital asset listing data is identified. Hybrid asset management data based on the digital asset listing data and physical asset listing data of the physical asset. The hybrid asset management operation is executed to cause display of the digital asset listing data for the digital asset, cause display of the physical asset listing data for the physical asset, and cause display of the hybrid asset management data on a hybrid asset management interface.

### BACKGROUND

An item listing platform supports storing items in item databases and providing a search system for receiving queries and identifying search result items based on the queries. An item listing platform may also provide a computing environment with features for managing collectible items. For example, the item listing platform can provide asset management functionality to buy, sell, and trade culturally and historically significant collectible items or assets. The item listing platform can also support items (e.g., digital assets or non-fungible tokens—“NFTs”) that are maintained using a blockchain system. The blockchain is a type of distributed ledger technology that consists of growing list of records—called blocks—that are securely linked together using cryptography.

Conventionally, item listing platforms are not configured with a comprehensive computing logic and infrastructure to manage digital collectible assets in combination with physical collectible assets. In particular, item listing platforms have traditionally provided support for managing physical assets and some types of digital assets. Users now have both physical assets and digital assets including NFT digital assets. Moreover, NFT digital assets can be twinned with physical assets that share several attributes. When digital assets are specifically NFT digital assets, if not properly managed, NFT digital assets can affect efficient functioning of computing components associated item listing platform of the NFT digital assets. As such, a comprehensive item listing platform—with an alternative basis for performing item management operations—can improve computing operations and interfaces in the item listing platform.

### SUMMARY

Various aspects of the technology described herein are generally directed to systems, methods, and computer storage media for, among other things, providing a hybrid asset management service for physical assets and digital assets. Item listing platforms lack interface integration of management functionality for both physical assets and digital assets in a combined interface. The hybrid asset management service includes interface elements and hybrid asset management operations for combined management of both physical assets and digital assets. An item listing platform can reuse an existing item listing platform system components (e.g., physical storage vault, payment system, blockchain system) to provide a single platform to manage both physical assets and digital assets. In particular, the item listing platform can interact with external systems (e.g., external NFT marketplaces, crypto wallets, and blockchain systems) to integrate and automate functionality associated with the item listing platform with the external systems.

In operation, a request to perform a hybrid asset management operation for a digital asset is received. Based on the request, digital asset listing data of the digital asset is accessed. A physical asset associated with the digital asset listing data is identified. Hybrid asset management data based on the digital asset listing data and physical asset listing data is generated. The hybrid asset management operation is executed to cause display of the digital asset listing data for the digital asset, cause display of the physical asset listing data for the physical asset, and cause display of the hybrid asset management data on a hybrid asset management interface.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The technology described herein is described in detail below with reference to the attached drawing figures, wherein:

FIGS. 1A and 1B are block diagrams of an exemplary item listing platform system for providing a hybrid asset management service for physical assets and digital assets, in accordance with aspects of the technology described herein;

FIG. 1C-1E are hybrid asset management system interfaces of an exemplary item listing platform system for providing a hybrid asset management service for physical assets and digital assets, in accordance with aspects of the technology described herein;

FIG. 2A is a block diagram of an exemplary item listing platform system for providing a hybrid asset management service for physical assets and digital assets, in accordance with aspects of the technology described herein;

FIG. 2B is a block diagram of an exemplary item listing platform system for providing a hybrid asset management service for physical assets and digital assets, in accordance with aspects of the technology described herein;

FIG. 3 provides a first exemplary method of providing a hybrid asset management service for physical assets and digital assets, in accordance with aspects of the technology described herein;

FIG. 4 provides a second exemplary method of providing a hybrid asset management service for physical assets and digital assets, in accordance with aspects of the technology described herein;

FIG. 5 provides a third exemplary method of providing a hybrid asset management service for physical assets and digital assets, in accordance with aspects of the technology described herein

FIGS. 6A and 6B provide block diagrams of an exemplary blockchain computing environment suitable for use in implementing aspects of the technology described herein;

FIG. 7 provides a block diagram of an exemplary distributed computing environment suitable for use in implementing aspects of the technology described herein; and

FIG. 8 is a block diagram of an exemplary computing environment suitable for use in implementing aspects of the technology described herein.

### DETAILED DESCRIPTION OF THE INVENTION

### Overview

An item listing platform supports storing items (or assets) in item databases and providing a search system for receiving queries and identifying search result items based on the queries. An asset (e.g., physical asset or digital asset) refers to an item that is provided for listing on an item listing platform. Search systems support identifying, for received queries, result items from item databases. Item databases can specifically be for content platform or item listing platforms such as EBAY content platform, developed by EBAY INC., of San Jose, California. An item listing platform may also provide a computing environment with features for managing collectible assets. For example, the item listing platform can provide asset management functionality to buy, sell, and trade culturally and historically significant collectible assets. The item listing platform can also support items (e.g., digital assets or non-fungible tokens—“NFTs”) that are maintained using a blockchain system. The blockchain is a type of distributed ledger technology that consists of growing list of records—called blocks—that are securely linked together using cryptography.

Conventionally, item listing platforms are not configured with a comprehensive computing logic and infrastructure to manage digital collectible assets in combination with physical collectible assets. In particular, item listing platforms have traditionally provided support for managing physical assets and some types of digital assets. Users now have both physical assets and digital assets including NFT digital assets. No effective single platform exists that allows collectors who own both physical assets and digital assets to manage their portfolio in one place. Buyers and sellers have to leave the item listing platform to perform operations on their digital assets (e.g., NFTs) that are managed via another item listing platform (e.g., external NFT marketplace).

In addition, without integration of management of physical assets and digital assets computing operations can be inefficient in providing interfaces and functionality that is based on having information associated with both types of assets. For example, opportunities to provide recommendations for digital assets based on physical assets or physical assets based on digital assets are missed without adequate integration of hybrid asset management functionality.

Moreover, with digital assets that are twinned with physical assets—where physical assets are stored in a physical storage vault—there exists some challenges to integrating functionality to effectively manage both types of assets. In particular, when digital assets are specifically NFT digital assets, if not properly managed, NFT digital assets can affect efficient functioning of computing components associated item listing platform of the NFT digital assets. As such, a comprehensive item listing platform—with an alternative basis for performing item management operations—can improve computing operations and interfaces in the item listing platform.

Embodiments of the present invention are directed to systems, methods, and computer storage media for, among other things, providing a hybrid asset management service for physical assets and digital assets. Item listing platforms lack interface integration of management functionality for both physical assets and digital assets in a combined interface. The hybrid asset management service includes interface elements and hybrid asset management operations for combined management of both physical assets and digital assets. An item listing platform can reuse an existing item listing platform system components (e.g., physical storage vault, payment system, blockchain system) to provide a single platform to manage both physical assets and digital assets. In particular, the item listing platform system can interact with external systems (e.g., external NFT marketplaces, crypto wallets, and blockchain systems) to integrate and automate functionality associated with the item listing platform with the external systems.

At a high level, an item listing platform system supports managing physical assets and digital assets together. In particular, a user can manage their physical assets that are in a physical storage vault of the item listing platform system, physical assets that are stored by the user, digital assets that are associated with the item listing platform system or digital assets that are associated with an external item listing platform. As such, the system can be referred to as a hybrid asset management system that specifically manages collectible physical assets and digital assets. The physical assets and digital assets that are controlled by the item listing platform system can be “internal assets” and physical assets and digital assets that are not controlled by the item listing platform system can be “external assets”. In this way, the item listing platform system provides a hybrid asset management system and a hybrid asset management client for performing operations associated with a hybrid asset management service for internal or external physical assets and digital assets. The hybrid asset management system can operate with legacy components of the provide legacy operations that are integrated into the hybrid asset management service.

The hybrid asset management service can support different types of hybrid asset management operations to facilitate managing physical assets and digitals assets. The hybrid asset management operations can be associated with interfaces that help summarize and present information associated with physical asset data and digital asset data. The hybrid asset management service can specifically operate to support integrating an external NFT marketplace, an external crypto wallet, and an external blockchain system into the item listing platform system such that physical assets and digital assets can be managed together. For example, a user can import NFT digital assets based on providing access to their external crypto wallet that is associated with an external NFT marketplace and a blockchain system. Adding NFT digital assets associated with an external marketplace and a blockchain system can help in providing a unified view of both physical assets—including twinned assets of NFT digital assets—and digital assets.

The hybrid asset management service can leverage legacy components to support managing imported digital assets. For example, an item listing data framework that supports managing physical assets and digital assets in the item listing platform system can be used to import digital assets from external NFT marketplaces. The item listing data framework can be used to map attributes or features of a digital asset associated with a public blockchain into a data structure for storing the imported digital asset in a manner that is compatible with the item listing platform system. The item listing platform system can use the digital asset data in the data structure to automatically link the digital asset with a corresponding physical asset, and also automatically generate different types of item listings (e.g., a digital asset only item listing or a hybrid physical-digital item listing). The digital asset can be linked to a corresponding physical asset that is owned by the same user that owns the digital asset. For example, a digital asset of a baseball card and be linked to the physical asset of the baseball card in a physical storage vault. In addition, recommendations of items in the item listing platform system can be generated for a user based on digital asset data of an imported NFT digital asset. The digital asset data can be used to recommend physical assets and other digital assets that are part of the item listing platform. The hybrid asset management service can also support different types of interfaces (e.g. seller interfaces and buyer interfaces) for supporting the functionality described above.

By way of illustration, a user may mint an NFT digital asset with an external NFT marketplace associated with a blockchain system. The blockchain system can store a contract address and token that is associated with an external crypto wallet of the user. A contract address can be stored on the blockchain system a corresponding token operates as a pointer to an external crypto wallet of the user. The user may also buy or have other NFT digital assets in the external crypto wallet using other mechanisms. The user can then import the NFT digital asset into the item listing platform system. In particular, the item listing platform system can fetch the contract address and token from the blockchain system based on information in the user's crypto wallet. The contract address and token can facilitate getting digital asset data (e.g., NFT metadata) from the blockchain of the blockchain system. The digital asset data can be used to automatically create a listing of the NFT digital asset in the item listing platform system and facilitate selling the NFT digital asset or the NFT digital asset and a twinned physical asset on the item listing platform system.

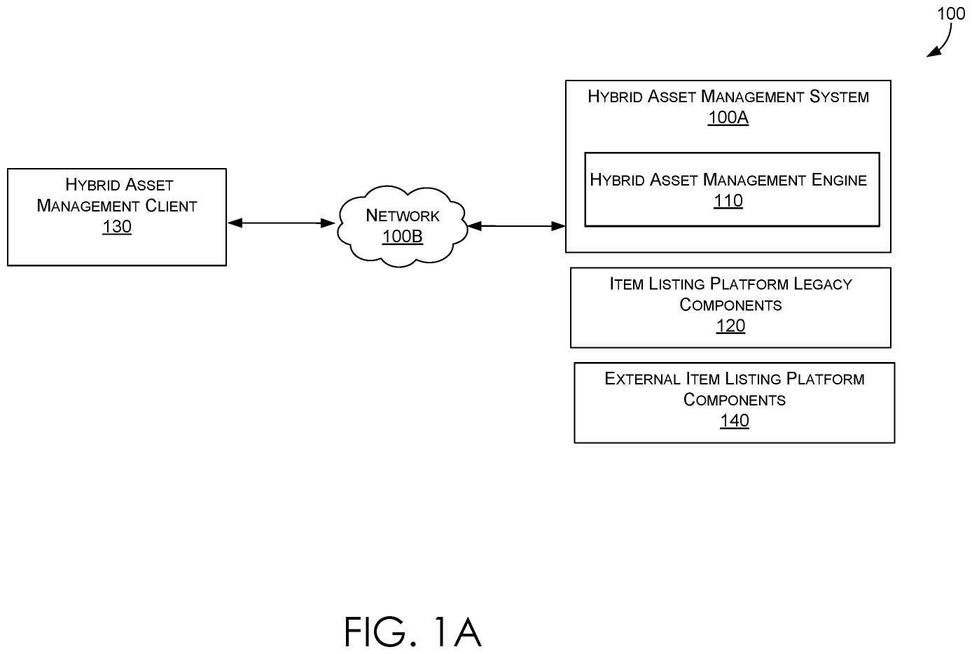

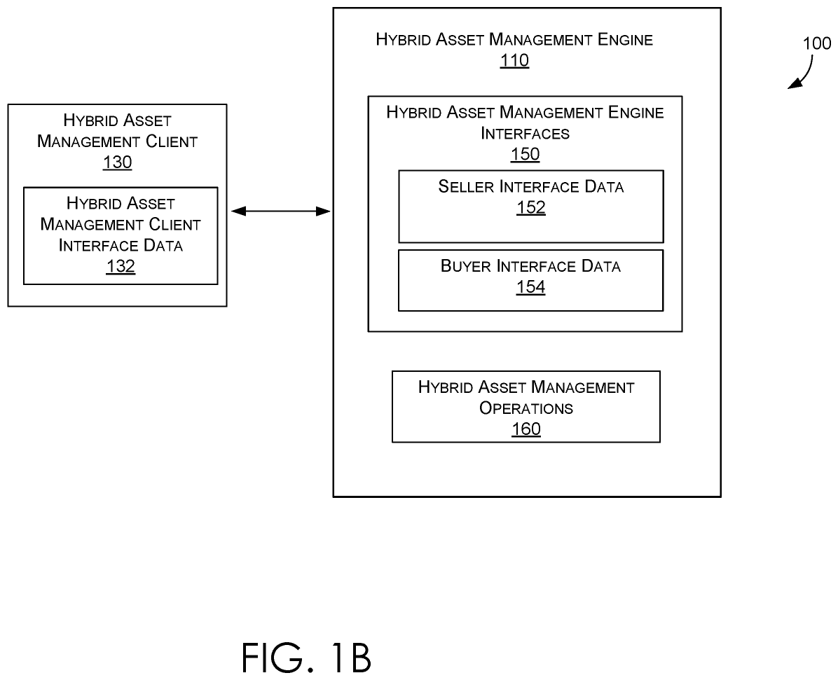

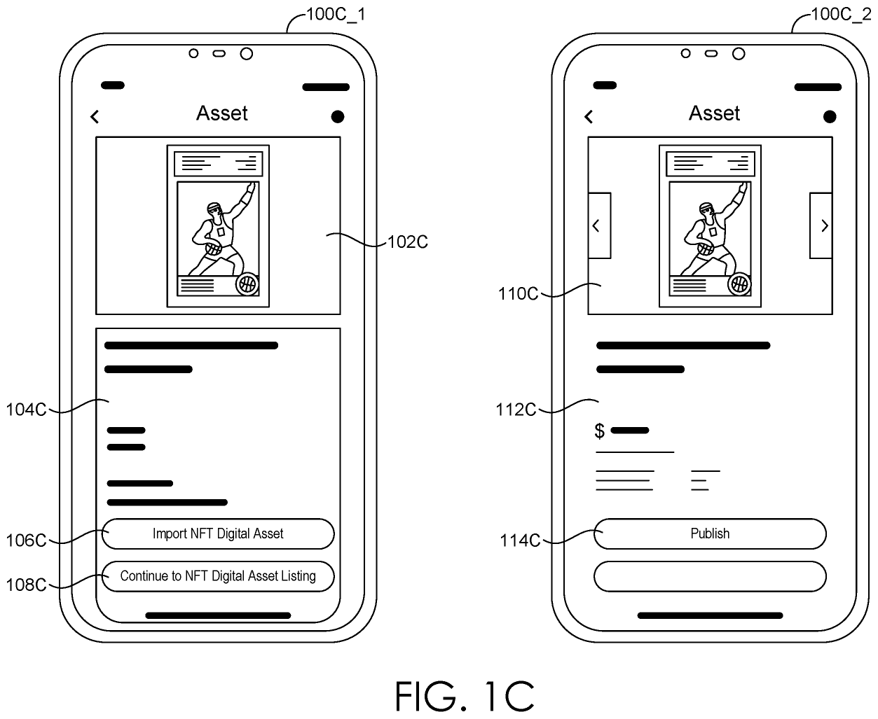

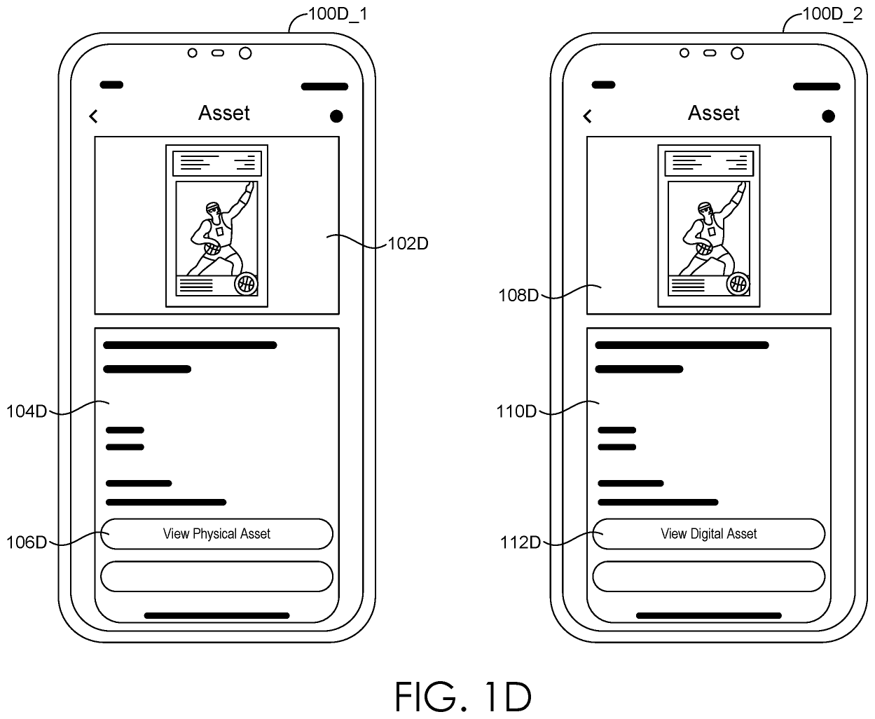

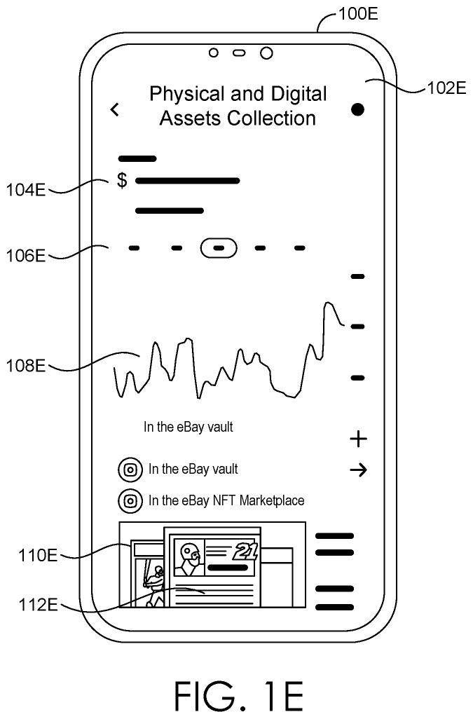

Aspects of the technical solution can be described by way of examples and with reference to FIGS. 1A-1E. FIG. 1A illustrates an item listing platform system 100 that includes hybrid asset management system 100A, network 100B, hybrid asset management engine 110, item listing platform legacy components 120, hybrid asset management client 130, and external item listing platform components 160.

The item listing platform system 100 provides a system (e.g., hybrid asset management system 100A) that includes an engine (e.g., hybrid asset management engine 110) for performing operations (e.g., hybrid asset management operations) discussed herein. The hybrid asset management engine 110 can specifically communicate with hybrid asset management client 130 (e.g., a client device) that can access the item listing platform system 100. For example, a user—via the hybrid asset management client 130—can communicate a request to perform hybrid asset management operations including importing an NFT digital asset using external item listing platform components. The external item listing platform components 140 can include an external NFT marketplace, an external crypto wallet, or a public blockchain. Item listing platform legacy components 120 can include a recommendations system, payments system, a physical storage vault that are associated with the item listing platform system 100A and can be leveraged to perform hybrid asset management operations based on physical asset data and digital asset data.

With reference to FIG. 1B, FIG. 1B illustrates hybrid asset management engine 110 including hybrid asset management client 130 having hybrid asset management client interface data 132, hybrid asset management engine interfaces 150 having seller interface data and buyer interface data; and hybrid asset management operations.

The hybrid asset management engine 110 and hybrid asset management client 130 provide interfaces (i.e., hybrid asset management client interface data, seller interface data, buyer interface data) and operations (i.e., hybrid asset management operations 160). The hybrid asset management engine 110 and the hybrid asset management client 130 can operate in a server-client relationship to provide the hybrid asset management service. For example, a user can communicate a request from the hybrid asset management client 130 to execute a hybrid asset management operation from the hybrid asset management operations 140. Based on executing the hybrid asset management operation, interface data (e.g., seller interface data 152 or buyer interface data 154) is generated and communicated for presentation—as hybrid asset management interface data 132—in the hybrid asset management client 130. The hybrid asset management client 130 can support—for example—causing display of the digital asset listing data for the digital asset or causing display of physical asset listing data for the physical asset. The hybrid asset management client 130 can provide seller interface data associated with seller operations and buyer interface data associated with buyer operations.

With reference to FIG. 1C, FIG. 1C illustrates item listing platform system interfaces 100C_1 and 100C_2 associated with importing an NFT digital asset associated with an external NFT marketplace and listing the NFT digital asset, respectively. The item listing platform system interface 100C_1 includes NFT digital asset 102C associated with an external NFT marketplace and external blockchain; digital asset data (e.g., blockchain transaction data and attributes of the NFT digital asset) that is retrieved from the external blockchain; button 106C that triggers importing the NFT digital asset into the item listing platform system; and button 108C that triggers automatically generating an item listing for the NFT digital asset. The item listing platform system interface 100C_2 includes the NFT digital asset 110C; NFT digital asset item listing data 112C (e.g., price and other attributes of the NFT digital asset); and button 114C that triggers publishing the NFT digital asset for sale in the item listing platform system. Other variations and combination of interfaces associated with importing NFT digital assets and listing NFT digital assets are contemplated with embodiment described herein.

With reference to FIG. 1D, FIG. 1D illustrates an item listing platform system interface 100D_1 and 100D_2 associated with a physical-digital hybrid listing associated with a hybrid asset management service. The item listing platform interface 100D_1 includes NFT digital asset 102D; digital-asset-listing interface portion 104D for displaying digital asset data (or digital asset listing data); and button 106D that triggers viewing the corresponding physical asset. The item listing platform interface 100D_2 includes physical asset 108D; physical-asset-listing interface portion 110D for displaying physical asset data (or physical asset listing data); and button 112D that triggers viewing the corresponding digital asset. Other variations and combination of physical-digital hybrid listings for twinned physical assets and digital assets are contemplated with embodiment described herein.

With reference to FIG. 1E, FIG. 1E illustrates an item listing platform system interface 100C that illustrates a hybrid asset management interface 102E. The hybrid asset management interface 102E includes hybrid asset management data based on physical asset data (or physical asset listing data) and digital asset data (or digital asset listing data). The hybrid asset management interface 102E can include listing data interface portion 104E, filtering interface portion 106E, graphical visualization interface portion 108E, a hybrid physical-digital asset selector interface portion 110E with digital asset 112E and physical asset 114E.

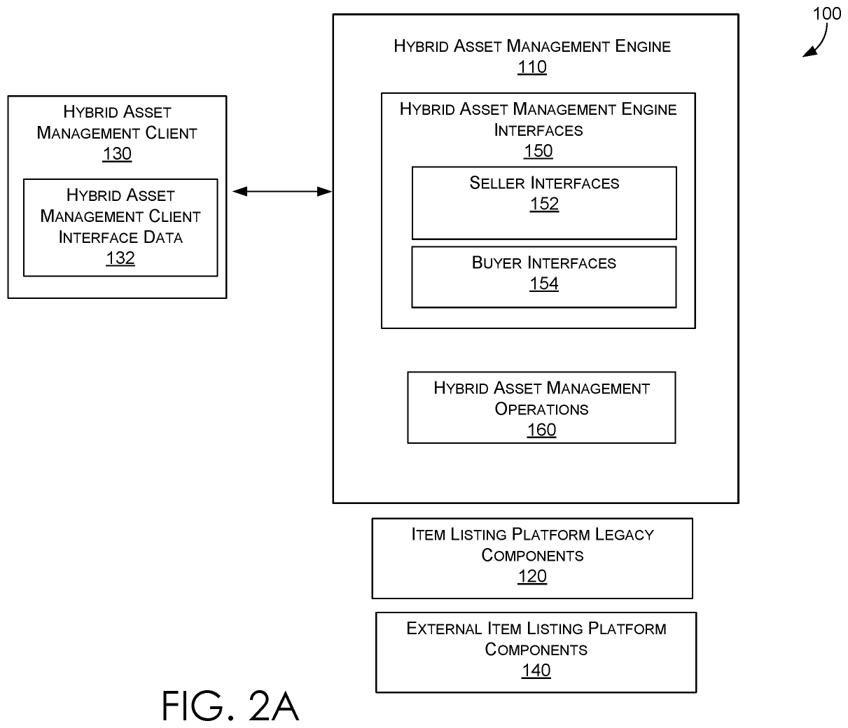

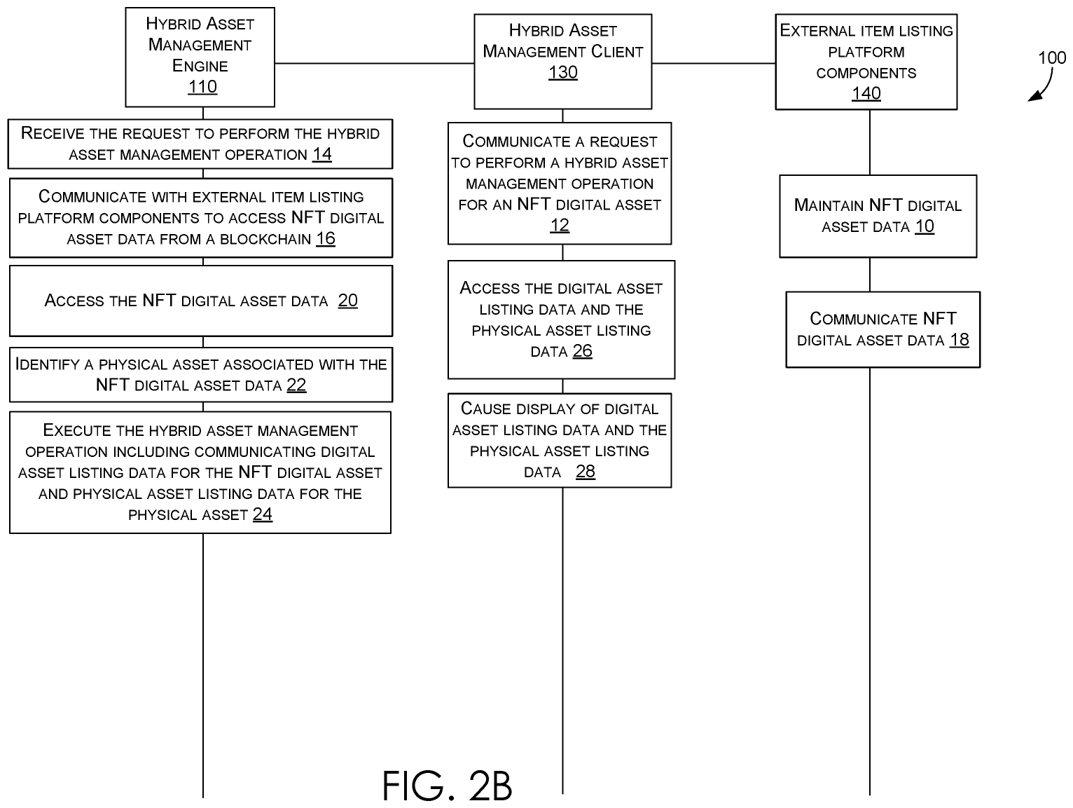

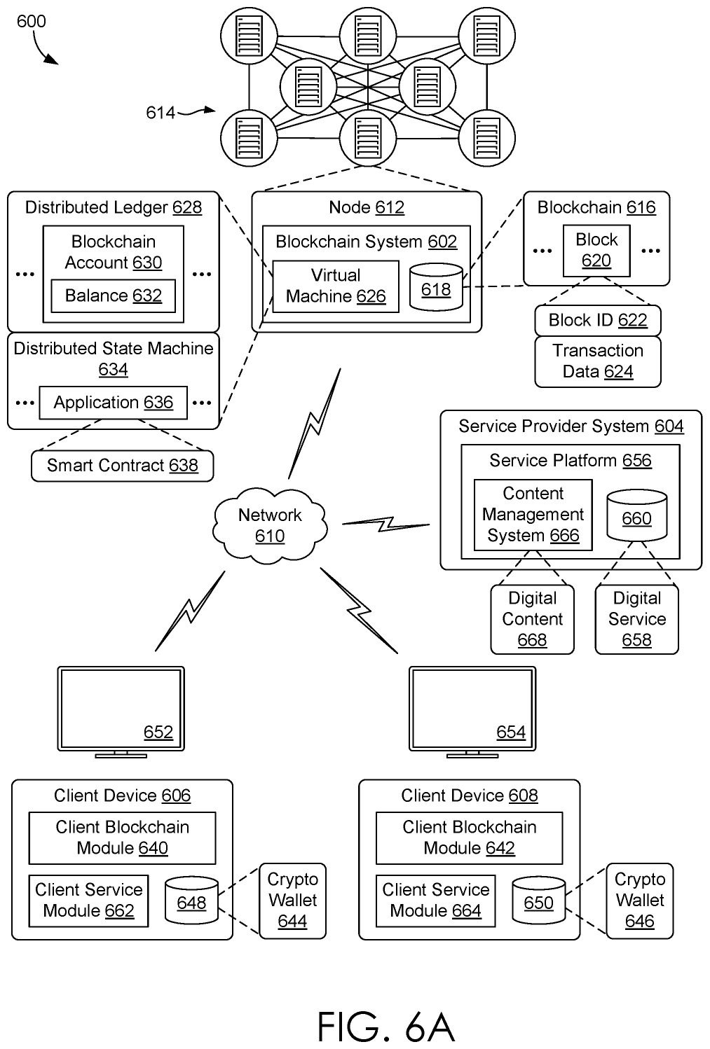

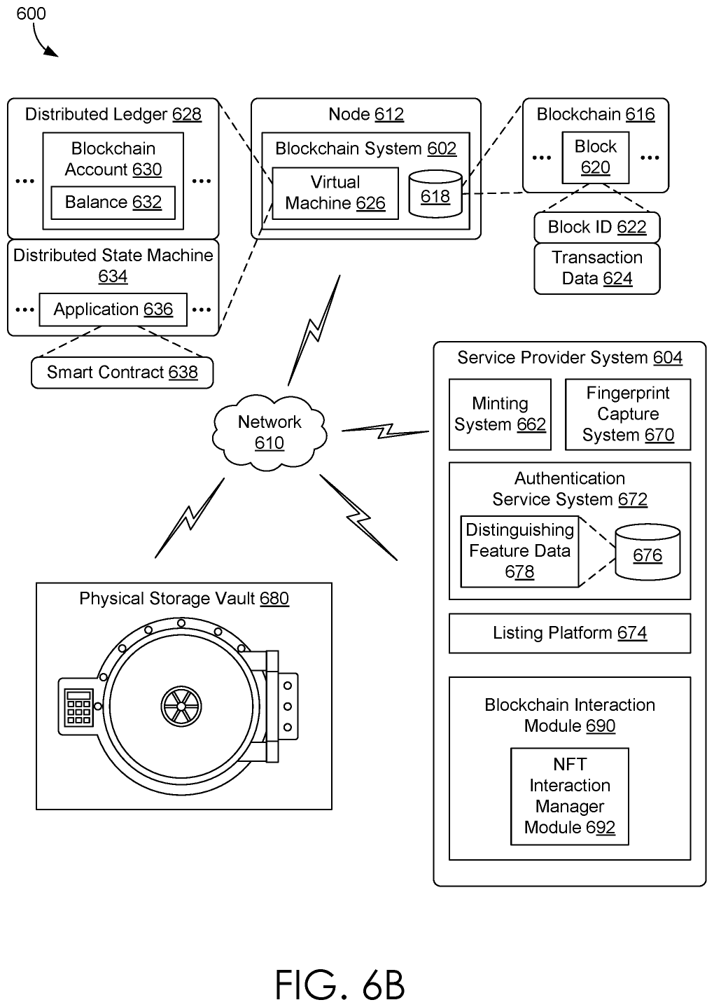

Aspects of the technical solution can be described by way of examples and with reference to FIGS. 2A and 2B. FIG. 2A is a block diagram of an exemplary technical solution environment, based on example environments described with reference to FIGS. 6A, 6B, 7 and 8 for use in implementing embodiments of the technical solution are shown. Generally the technical solution environment includes a technical solution system suitable for providing the example item listing platform system 100 in which methods of the present disclosure may be employed. In particular, FIG. 2A shows a high level architecture of the item listing platform system 100 in accordance with implementations of the present disclosure. Among other engines, managers, generators, selectors, or components not shown (collectively referred to herein as “components”), the item list platform system 100 of FIG. 2A corresponds to FIGS. 1A and 1B.

With reference to FIG. 2A, FIG. 2A illustrates item listing platform system 100 with hybrid asset management engine 110; item listing platform legacy components 120; hybrid asset management client 130 having hybrid asset management client interface data 132; external item listing platform components 140; hybrid asset management engine interfaces 150 including seller interfaces 152 and buyer interfaces 154; and hybrid asset management operations 160.

The hybrid asset management engine 110 can receive a request to perform a hybrid asset management operation. The request can be received from the hybrid asset management client 130 associated with a user (e.g., a seller or a buyer). The request can be received via a seller interface, a buyer interface, or any other type of interface associated with the hybrid asset management client 130. The hybrid asset management operation is associated with the hybrid management service of the item listing platform system 100 that integrates management of physical assets and digital assets. The hybrid asset management service further supports integrating an external NFT marketplace, an external crypto wallet, and an external blockchain system with the item listing platform of the hybrid asset management service.

The hybrid asset management engine 110 accesses digital asset listing data of the digital asset from a blockchain system. The blockchain system can be a public blockchain system associated with a third-party blockchain system provider, the blockchain system is associated with a plurality of NFT marketplaces. Accessing the digital asset listing data includes mapping digital asset data from the blockchain system to an item listing data framework of the item listing platform. The digital asset listing data is used to identify a physical asset associated with the digital asset listing data. The physical asset can be a twinned physical asset associated with the digital asset. The physical asset can also be a recommended physical asset from the item listing platform that is associated with the digital asset. For example, upon importing a digital asset into the item listing platform, a recommendation system of the item listing platform can be used to identify and communicate a physical asset that corresponds to the digital asset as a recommended physical asset. The recommended physical asset can be provided to the user via one or more different interfaces associated with the item listing platform.

The hybrid asset management engine 110 executes the hybrid asset management operation. Executing the hybrid asset management operation can include causing display of the digital asset listing data for the digital asset and causing display of physical asset listing data for the physical asset. Executing the hybrid asset management operation can also include automatically generating a hybrid physical-digital asset listing associated with the item listing platform, where the hybrid physical-digital asset listing comprises a physical-asset-listing interface portion and a digital-asset-listing portion.

Executing the hybrid asset management operation can further include generating a hybrid asset management interface comprising and hybrid asset management data based on the physical asset listing data and the digital asset listing data. The hybrid asset management data refers to combined data from the physical assets and digital assets. The hybrid asset management data can generated to display physical asset data and digital asset data on a hybrid asset management interface. The hybrid asset management interface comprises a dashboard listing of physical assets and digital assets. The hybrid asset management data can be associated with a user account, where the hybrid asset management data is generated based at least in part on the user account. For example, hybrid asset management data can be generated based on features of a particular user associated with the user account; or based on additional information about other assets (e.g., pricing information from other physical assets and digital assets) in the item listing platform system. The hybrid asset management engine 110 can communicate a notification to cause transfer ownership of the physical asset based on an external location or an internal location associated with a physical storage vault associated with the physical asset. For example, a user may request that a physical asset be transferred from the physical storage vault to the user's address or be transferred from a physical storage vault location associated with the user (e.g., seller) a physical storage vault location associated with another user (e.g., buyer).

With reference to FIG. 2B, FIG. 2B illustrates hybrid asset management engine 110, hybrid asset management client 120, and external item listing platform components 140 for providing a hybrid management service to managing physical assets and digital assets. At block 10, the external item listing platform components (e.g., crypto wallet, blockchain system) maintain NFT digital asset data. At block 12, the hybrid asset management client 130 communicates a request perform a hybrid asset management operation for an NFT digital asset. At block 14, the hybrid asset management engine 110 receives the request to perform the hybrid asset management operation; at block 16 communicates with the external item listing platform components 140 to access NFT digital asset data from a blockchain. At block 18, the external item listing platform components communicate the NFT digital asset data. At block 20, the hybrid asset management engine accesses the NFT digital asset data. At block 22, the hybrid asset management engine 110 identifies a physical asset associated with the NFT digital asset data; and at block 24, executes the hybrid asset management operation include communicating digital asset listing data for the NFT digital asset and physical asset listing data for the physical asset. At block 26, the hybrid asset management client 130 accesses the digital asset listing data and the physical asset listing data; and at block 28, causes display of the digital asset listing data and the physical asset listing data.

### Example Methods

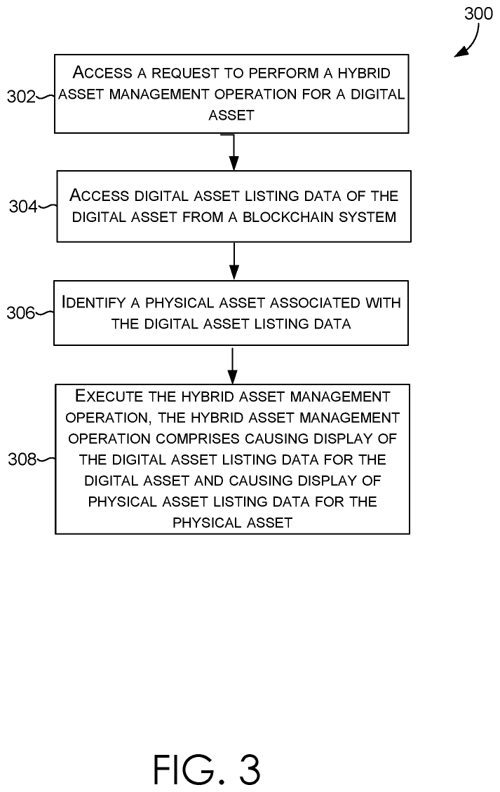

With reference to FIGS. 3, 4, and 5 flow diagrams that illustrate methods for providing a hybrid asset management service for physical assets and digital assets. The methods may be performed using the item listing platform system described herein. In embodiments, one or more computer-storage media having computer-executable or computer-useable instructions embodied thereon that, when executed, by one or more processors can cause the one or more processors to perform the methods (e.g., computer implemented method) in an item listing platform system (e.g., computerized system or computer system).

Turning to FIG. 3, a flow diagram is provided that illustrates a method 300 for providing a hybrid asset management service for physical assets and digital assets. At block 302, a hybrid asset management engine accesses a request to perform a hybrid asset management operation for a digital asset. At block 304, the hybrid asset management engine accesses digital asset listing data of the digital asset from a blockchain system. At block 306, the hybrid asset management engine identifies a physical asset associated with the digital asset listing data. The physical asset is associated with physical asset listing data. At block 308, the hybrid asset management engine executes the hybrid asset management operation, executing the hybrid asset management operation comprises causing display of the digital asset listing data for the digital asset and causing display of the physical asset listing data for the physical asset.

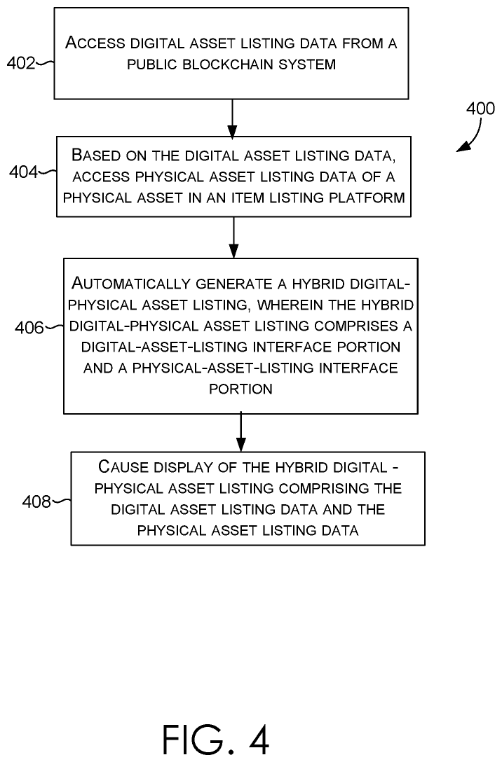

Turning to FIG. 4, a flow diagram is provided that illustrates a method 400 for providing a hybrid asset management service for physical assets and digital assets. At block 402, a hybrid asset management engine accesses digital asset listing data from a public blockchain system. At block 404, based on the digital asset listing data, the hybrid asset management engine accesses physical asset listing data of a physical asset in an item listing platform. At block 406, the hybrid asset management engine automatically generates a hybrid digital-physical asset listing. The hybrid digital-physical asset listing comprises a digital-asset listing interface portion and a physical-asset-listing interface portion. At block 408, the hybrid asset management engine causes display of the hybrid-physical asset listing comprising the digital asset listing data and the physical asset listing data.

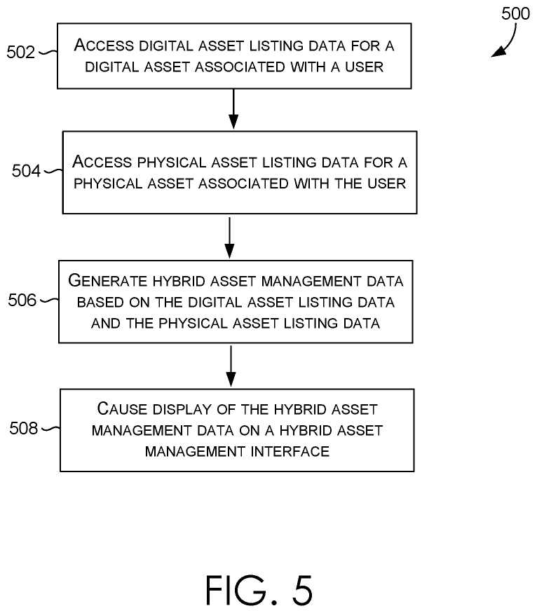

Turning to FIG. 5, a flow diagram is provided that illustrates a method 500 for providing a hybrid asset management service for physical assets and digital assets. At block 502, a hybrid asset management engine accesses digital asset listing data for a digital asset associated with a user. At block 504, the hybrid asset management engine accesses physical asset listing data for a physical asset associated with the user. At block 506, the hybrid asset management engine generates hybrid asset management data based on the digital asset listing data and the physical asset listing data. At block 508, the hybrid asset management engine causes display of the hybrid asset management data on a hybrid asset management interface.

### Technical Improvement

Embodiments of the present invention have been described with reference to several inventive features (e.g., operations, systems, engines, and components) associated with an item listing platform system. Inventive features described include: operations, interfaces, data structures, and arrangements of computing resources associated with providing the functionality described herein relative with reference to a hybrid asset management system.

Embodiments of the present invention relate to the field of computing, and more particularly to item listing platform systems. The following described exemplary embodiments provide a system, method, and program product to, among other things, execute hybrid asset management operations that provide interfaces associated with digital asset listing data and physical asset listing data. Therefore, the present embodiments have the capacity to improve the technical field of item listing platform technology by providing more efficient user interfaces. For example, interfaces described for this technical solution provide a specific improvement over prior systems, resulting in an improved user interface for an item listing platform system. In particular, the particular manner of summarizing and presenting physical asset listing data and digital asset listing data do not use conventional user interface methods. The technical solution addresses conventional item listing platforms' lack of integration of management of physical assets and digital assets based on improving item listing platform technology by improving user's efficiency in managing physical assets and digital assets via user interfaces.

Functionality of the embodiments of the present invention have further been described, by way of an implementation and anecdotal examples—to demonstrate that the operations for providing a hybrid asset management service for physical assets and digital assets as a solution to a specific problem in item listing platform technology to improve computing operations in item listing platform systems. Overall, these improvements result in less CPU computation, smaller memory requirements, and increased flexibility in item listing platform systems when compared to previous conventional item listing platform system operations performed for similar functionality.

### ADDITIONAL SUPPORT FOR DETAILED DESCRIPTION OF THE INVENTION

### Example Blockchain Computing Environment

With reference to FIGS. 6A and 6B, FIGS. 6A and 6B illustrate an example blockchain computing environment 600 in which implementations of the present disclosure may be employed. In particular, the blockchain computing environment 600 includes a blockchain system 602, a service provider system 604, a plurality of client devices (e.g., client device 606 and client device 608) that are communicatively coupled, to one another, via a network 610. The blockchain system 602 is implemented by a plurality of nodes (e.g., node 612).

Node 612 is a runtime environment implemented using a processor, memory, and network resources of respective computing device 614 that operate as the infrastructure of the blockchain 616. A plurality of nodes store, communicate, process, and manage data that makes up the blockchain 616. The plurality of nodes are interconnected as illustrated to exchange data via the network 610.

The blockchain 616 is formed using a plurality of blocks (e.g., block 620). Block 620 includes a block identifier 622 and transaction data 624. Transaction data 624 of block 620 includes batches of validated transactions that are hashed and encoded. Each block 620 includes a cryptographic hash of a prior block in the blockchain, thereby linking the blocks to each other to form the blockchain 616. As a result, the plurality of blocks cannot be altered retroactively without altering each subsequent block in the blockchain 616 and in this way protects against attacks from malicious parties.

In order to generate the blocks 620 for addition to the blockchain 616, a node 612 is implemented as a “miner” to add a block of transactions to the blockchain 616. The other nodes of the blockchain system 602 then check if the block of transaction is valid, and based on this, determine whether to accept or reject this data. If valid, the block of transactions is stored—as transaction data 624 along with a block ID 622 for a respective block 620—“at the end” or “at the top” of the blockchain 616 along with a hash of a previous block in the chain. Nodes 612 then broadcasts this transaction history via the network 610 for sharing with other nodes. This acts to synchronize the blocks 620 of the blockchain 616 across the distributed architecture of the blockchain system 602. Other types of nodes are also included as part of the blockchain system 602. In one such example, full nodes are nodes that store an entirety of the blockchain 616—for example, locally in computer-readable storage media of a respective store device 618. Other types of nodes are also employed to implement additional functionality to govern voting events, execution or protocol operations, and rules enforcement.

Cryptocurrencies are the native asset of the blockchain 616, and tokens are created “on top” of these blockchains. Tokens may be created “on top” of the blockchain 616 by using a “token standard” which allows the token to interoperate with the blockchain 616's network of nodes according to one or more protocols of the blockchain, such that transaction data and the hashes of the blocks are leveraged to create, trade, and update tokens. By way of example, the Ethereum blockchain's native asset is ether (ETH), a cryptocurrency. Nevertheless, tokens may be created on top of Ethereum's blockchain by using one or more of Ethereum's token standards for creating tokens, such as by using ERC-20, ERC-721, ERC-1155, and EIP-2309.

The blockchain system 602 implements a virtual machine 626 that is representative of a diverse range of functionality made possible by leveraging the blockchain 616. In a first such example, the virtual machine 626 implements a distributed ledger 628 of accounts 630 and associated balances 632 of those accounts 630. Distributed ledgers 628 support secure transfer of digital assets (e.g. tokens or coins of cryptocurrencies) between accounts 630 without management by a central authority through storage as part of the transaction data 624 of the blockchain 616. Through synchronized and distributed access supported by the blockchain 616 as described above, changes to balances 632 (e.g., a number of tokens) are visible to any entity with access to the blockchain 616. Techniques are also implemented to support management of balances 632 across the accounts 630—for example, to enforce rules that a respective account 630 does not transfer more tokens than are available based on a balance 632 specified for that account 630.

In another example, the virtual machine 626 implements a distributed state machine 634 that supports application 636. The distributed state machine 634 is implemented along with the transaction data 624 within the blocks of the blockchain 116 such that the blocks describe accounts and balances as described above for the distributed ledger 628. The transaction data 624 also supports a machine state, which can change from block to block of the blockchain 616. In one example, the application 636 is executable as part of a “Turing-complete” decentralized virtual machine that is distributed across the nodes of the blockchain system 602. As Turing-complete, the application 636 is computationally universal to perform computing device operations, such as, logic or computing functions. The application 636 is executable by a processing system of a computing device as software that is storable in a computer-readable storage media of nodes 612 to perform a variety of operations.

An example of an application 636 that is executable as part of the distributed state machine 634 is a smart contract 638. A smart contract is a computer program or a transaction protocol that is intended to automatically execute, control or document events and actions according to the terms of a contract or an agreement. A smart contract 638 is executable automatically and without user intervention (or with partial human interaction as inputs when desired) by nodes of the distributed state machine 634. Execution of the smart contract 638 includes obtaining data from a specified data source (e.g., devices, APIs, and so forth that are accessible via the network 610), and based on this data, initiating one or more operations based on conditions described in the smart contract 138. In one example, the smart contract 638 is a type of account 130 that includes a balance 632 and initiates transactions based on conditions specified by the smart contract 638—for example, to support automated escrow and other functionalities. A variety of other examples are also contemplated that support implementation of any executable operations by a computing device using software.

In an example of a token, the smart contracts 638 implement non-fungible tokens (NFTs). NFTs include digital assets that are provably unique and as such cannot be duplicated or divided. As such, NFTs are not exchanged as having a same value as coins in cryptocurrency, but rather are digital assets having identifying information recorded as part of the smart contract 638. This identifying information is immutably recorded on that token's blockchain 616 and this ownership of the token is also recorded and tracked. A variety of information is storable as part of the digital content represented by the NFT, examples of which include digital images, digital media, digital contract, executable instructions of an application 636 as described above, secure file links, in-game tokens, digital artwork, and so forth.

By way of illustration, an NFT can correspond to an item (e.g., a physical item or digital content) and describes that item. An NFT refers to a unique token on a blockchain as proof of ownership of an item. Thus, the NFT functions to verify the item that is the subject to the transaction and as such increases value of the item through publicly verifiable ownership of the NFT. To leverage this “twinning” blockchain queries initiated by the service provider system 604 can be used to determine and verify ownership of the NFT. The data received from the blockchain queries provides the service provider system 604 with up-to-date data. This data is leveraged such that digital content 668 is exposed to the correct entity, and as such, improve the operation of the service provider system 604. Other examples of tokens are also contemplated that are fungible and as such are interchangeable with each other.

Client devices (e.g., client device 606 and client device 608) include respective client blockchain modules (e.g., blockchain module 640 and blockchain module 642) that are representative of functionality of client devices to interact with the blockchain system 602. For example, this functionality includes management of respective crypto wallets (e.g., crypto wallet 644 and crypto wallet 646) in local storage devices (e.g., local storage device 648 and local storage device 650). The crypto wallets can store public and private cryptographic keys that are used to support interaction with the blockchain system 602, and particularly respective accounts 620 of the blockchain system 602, using respective user interfaces (e.g., user interface 652, and user interface 654). Functionality of the client devices to access digital services of the service provider system 604 is represented by respective client service modules. The client service modules are configurable as browsers, network-enabled applications, third-party plugins, and so on to access the digital services 158 via the network 110.

A public key supports transactions to an address of an account derived from the public key, which are stored as part of the blockchain 616 to memorialize the transaction as part of transaction data 624. In one example, an address of an account is generated by first generating a private key (e.g., using a randomization technique). The corresponding public key is derived from the private key and the address of the account is then derived from the public key—for example, an entirety of the public key or as a shortened version of the public key. The private key is used to “unlock” transactions that are “locked” by the public key and gain access to the account—for example, access to coins, tokens, or other information maintained as part of the transaction.

In one example, a transaction is initiated by the client device 606 with client device 608. Data of the transaction is encrypted using a public key. The transaction is then signed by the client device 608 using the private key which indicates that the transaction has not been modified—for example, by encrypting the data being sent in the transaction using the private key. The transaction is then verifiable as authentic by using the public key included with the data. The nodes (e.g., node 612) using the accompanying public key to automatically verify authenticity that the transaction is signed using the private key. Transactions that fail authentication are rejected by the nodes. Authentic transactions are used as part of transaction data 624 in minting blocks by the nodes that are added to the blockchain 616 as part of the distributed ledger 628. In this way, the virtual machine 626 of the blockchain system 602 supports a variety of functionality through use of the distributed ledger 628, distributed state machine 634, and other blockchain and cryptographic functionality.

The block chain computing environment 600 also includes a service provider system 604 implementing a service platform 656 of digital services 658, illustrated as maintained in storage device 660 and are executable via a processing system. Digital services 658 involve electronic delivery of data and implementation of data functionality by computing devices to support a range of computing device operations. Digital services 658, for instance, include creation, management, and dissemination of digital content via the network 610 (e.g., webpages, applications, digital images, digital audio, digital video, and so forth). The digital services 658 are also implemented to control access to and transfer physical goods and services through corresponding digital content (e.g., sales, product listings, advertisements, etc.). Digital services 658 further pertain to operation of computational resources (e.g., processing, memory, and network resources) of computing devices that support the access to and management of digital content by the system.

The service provider system 604 also includes a content management system 666. The content management system 666 by the service provider system 604 is configured to generate, expose, and control access to digital content 668. The digital content 668 may be controlled through use of an application (e.g., application 636) generated by the service provider system 604 and executed by the distributed state machine 634. The service platform 656, for instance, includes a digital service 658 configured to support transactions of items (e.g., physical items or digital content, using service provider accounts).

By way of illustration, the digital content 668 is configurable to encourage retention of an NFT by an entity, such as a user, that owns the item. An example of this is configuring the digital content 668 to include an offer. The offer is redeemable by the service provider system 604 encourage future interaction with the service provider system 604, such as through a reduction in a transaction fee for a subsequent sale of the item or a different item via the service platform 656. In this way, the digital content 668 encourage an entity that possess the item to also maintain possession of the NFT, and this retain an ability to verify authenticity of the item associated with using the NFT.

Turning to FIG. 6B, the service provider system 604 includes a minting system 662, a fingerprint capture system 670, an authentication service system 672, and listing platform 674. The authentication service system 672 is depicted having storage 676 which stores distinguishing feature data 678, which the authentication service system 632 uses to authenticate physical items, including physical items for which digital twinned NFTs are created as discussed above in more detail herein.

It is to be appreciated that the service provider system 604 may include more, fewer, and/or different components than illustrated without departing from the spirit or scope of the described techniques. Additionally, portions or entireties of one or more of the components may be implemented at client devices, such as part of applications at the client devices. For instance, at least a portion of the fingerprint capture system 670 (or the other illustrated components) may be implemented at the client devices as at least part of an application, as a plug-in, via a web page output (e.g., displayed) by the client devices, and so on.

The illustrated blockchain computing environment 600 also includes physical storage vault 680, which may be utilized in one or more implementations, e.g., to store physical items having digital twinned NFTs for safe keeping. The physical storage vault 680 may be included as part of the service provider system 604 or may be controlled by a third party and simply associated with or otherwise accessible to the service provider system 604. Physical items of digital twin NFTs are stored in physical storage vaults. To enable respective users to initiate operations to create NFTs and to perform transactions involving NFTs, the client devices include components to interact within blockchain computing environment 600.

The minting system 662 is configured to “mint” NFTs. Minting an NFT refers to publishing a unique digital asset on a blockchain so that it can be bought, sold, and traded. To mint an NFT, the minting system 662 causes the NFT to be created on the blockchain 116 and programmatically encodes an association of metadata with the NFT. In accordance with the described techniques, for example, the minting system 662 is configured to mint digital twin NFTs of physical items. The metadata for a digital twin NFT may include a fingerprint of the physical item (e.g., a high-resolution image of one or more features of the item, a LIDAR scan of the physical item, a unique serial number engraved on the item, etc.) and digital content of the physical item (e.g., an image of the physical item for presentation, a video of the physical item, and/or a 3D model of the physical item). The metadata may also include other information, such as a digital record of traits of the physical item, a description of the item, a condition of the physical item (which can change over time), an indication that the physical item is an authentic physical item, item authenticity and owner verification records, an indication that the physical item is not an authentic physical item, a physical location where the item was minted (e.g., at a residence, at a location corresponding to a facility of the service provider system, at an event such as a concert or sporting event, and so on), locations of transactions involving the physical item, public addresses of wallets of owners of the NFT, and/or a current location of the physical item, to name just a few. In scenarios where the metadata includes an indication that the physical item is not an authentic physical item, the physical item may be a replica or an imitation of an authentic physical item, examples of which include a print of an original painting or other artwork and a replica jersey, to name just a few. In one or more implementations, information, or portions of the information, encoded into a digital twin NFT may be based on user input to enter the information, e.g., via a user interface of the service provider system 104 in connection with listing the item.

The minting system 662 may encode an association of this metadata with the digital twin NFT by, for example, encoding the actual data (e.g., the unique fingerprint and/or the digital content) in the digital twin NFT, encoding unique identifiers of the actual data in the digital twin NFT, and/or encoding one or more addresses where such data is located (e.g., a storage location) in the digital twin NFT. In operation, the minting system 662 provides data as specified by a token standard associated with the blockchain 616 to one or more of the nodes to mint a new digital twin NFT of a physical item. For example, the minting system 662 packages and communicates the actual metadata to be encoded and/or packages and communicates the association (e.g., identifier and/or addresses) to be encoded according to the token standard to the one or more nodes.

The fingerprint capture system 630 is configured to generate digital fingerprints of physical items that uniquely identify a given physical item from other physical items. The fingerprint capture system 630 generates those fingerprints based on captured features of the physical items, such as features captured using sensors of one or more client devices. As discussed below, the features may be captured using one or more sensors of client devices one or more sensors of the fingerprint capture system 630 (e.g., when configured with hardware to capture the features of physical devices), and/or sensors of other devices. By way of example, the client devices and/or the fingerprint capture system 630 may include a high resolution digital camera to capture high-resolution digital image features of physical items.

The authentication service system 632 is configured to verify whether a physical item corresponds to an authentic physical item. The authentication service system 632 may verify whether a physical item corresponds to an authentic physical item by matching the fingerprint of a physical item, as generated by the fingerprint capture system 630, to distinguishing feature data 638 of a known authentic physical item. The authentication service system 632 may do so by comparing a fingerprint, or captured features encoded in the fingerprint, to portions of the distinguishing feature data 638, e.g., searching the distinguishing feature data 638 for data having at least a threshold similarity to the fingerprint or portions of the fingerprint. The authentication service system 632 may then return a response indicating that a physical item is or is not an authentic physical item (or is unsure whether the physical item is or is not authentic) based on whether the fingerprint matches any of the distinguishing feature data 638.

The listing platform 634 is configured to generate listings for items and to expose those listings (e.g., publish them) to one or more client devices, such as via an online marketplace. For example, the listing platform 634 may generate listings for items for sale and expose those listings to client devices, such that the users of the client devices can interact with the listings via user interfaces to initiate transactions (e.g., purchases, add to wish lists, share, and so on) in relation to the respective item or items of the listings. In accordance with the described techniques, the listing platform 634 is configured to generate listings for physical items or property (e.g., collectibles, luxury items, clothing, electronics, real property, physical computer-readable storage having one or more video games stored thereon, and so on), services (e.g., babysitting, dog walking, house cleaning, and so on), digital items (e.g., digital images, digital music, digital videos) that can be downloaded via the network 610, and NFTs, to name just a few. Notably, the listing platform 634 is configured to generate a combined listing that includes both a physical item and a digital twin NFT of the physical item. The listing platform 634 may generate the combined listing, which lists both the physical item and the digital twin NFT, based on user input received from a client device associated with a user account (e.g., of the listing platform 634) and received via a user interface to generate the combined listing. For example, the service provider system 604 may initiate the minting of a digital twin NFT of a physical item and initiate the listing of both the physical item and the digital twin NFT responsive to receiving such user input via a user interface of an application as output at a client device.

Optionally, the service provider system 604 may store physical items at the physical storage vault 640, such as valuable physical items having digital twin NFTs. Storage of the underlying physical item at the physical storage vault 640 allows ownership of the digital twin NFT and the physical item to be easily transferred between owners without the hassle of physically moving the item to transfer possession, e.g., shipping the item or exchanging it between hands. Instead, the item may be transferred to the physical storage vault 640 for storage and remain in the physical storage vault 640 while ownership of the physical item and/or its digital twin NFT is transferred a number of times. The physical storage vault 640 may also maintain physical items where ownership is divided, using a digital twin NFT, into a number of fractions of ownership of the physical item, e.g., “shares” of the physical item issued according to terms of the digital twin NFT.

Turning to an NFT minting example, the blockchain interaction module 690 and the NFT interaction manager module 692 support interacting with the blockchain system 602 to cause an NFT to be minted. The NFT interaction manager module 692 causes initiation of minting by transmitting an NFT request to a blockchain system to mint the NFT for a blockchain account. A user having a user account obtains a physical item and a digital twin NFT of the physical item, such as by minting the digital twin NFT of the physical item or receiving it through a transfer process. For example, the user may obtain the physical item and digital twin NFT via a listing platform (e.g., listing platform 674), such as an online marketplace. Alternatively or additionally, the listing platform may obtain the physical item and the digital twin NFT of the physical item. Based on ownership of the physical item and the digital twin NFT, the listing platform generates a combined listing for the physical item and the digital twin NFT of the physical item. This may occur, for example, when an owner of the physical item and the digital twin NFT decides to transfer ownership of the physical item and the digital twin NFT to another user, e.g., in exchange for cryptocurrency. A listing platform may expose this combined listing to various client devices. The listing platform may also expose a selectable option to store the physical item in a physical storage vault, e.g., a selectable button or checkbox of a user interface.

### Example Distributed Computing System Environment

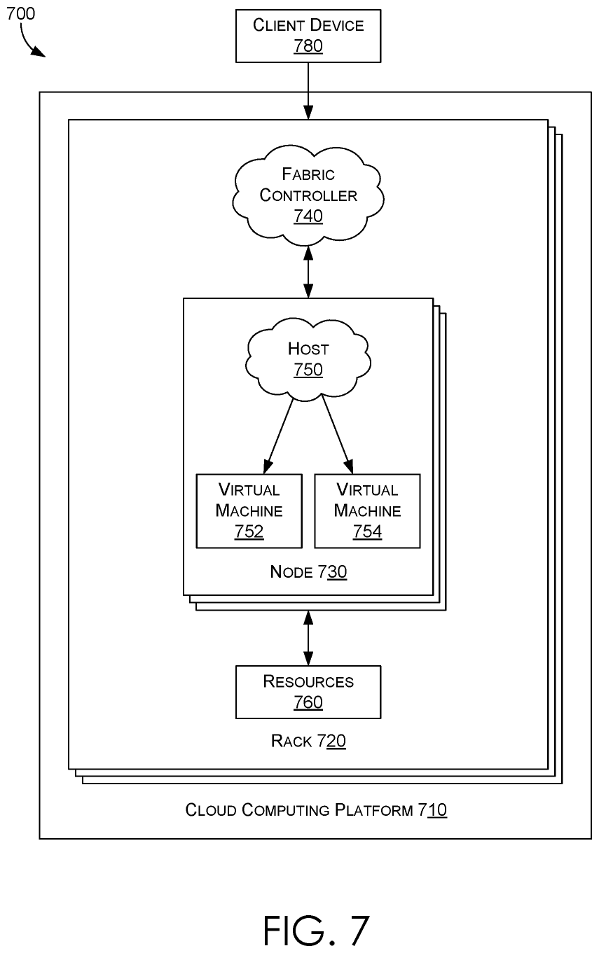

Referring now to FIG. 7, FIG. 7 illustrates an example distributed computing environment 700 in which implementations of the present disclosure may be employed. In particular, FIG. 7 shows a high level architecture of an example cloud computing platform 710 that can host a technical solution environment, or a portion thereof (e.g., a data trustee environment). It should be understood that this and other arrangements described herein are set forth only as examples. For example, as described above, many of the elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

Data centers can support distributed computing environment 700 that includes cloud computing platform 710, rack 720, and node 730 (e.g., computing devices, processing units, or blades) in rack 720. The technical solution environment can be implemented with cloud computing platform 710 that runs cloud services across different data centers and geographic regions. Cloud computing platform 710 can implement fabric controller 740 component for provisioning and managing resource allocation, deployment, upgrade, and management of cloud services. Typically, cloud computing platform 710 acts to store data or run service applications in a distributed manner. Cloud computing infrastructure 710 in a data center can be configured to host and support operation of endpoints of a particular service application. Cloud computing infrastructure 710 may be a public cloud, a private cloud, or a dedicated cloud.

Node 730 can be provisioned with host 750 (e.g., operating system or runtime environment) running a defined software stack on node 730. Node 730 can also be configured to perform specialized functionality (e.g., compute nodes or storage nodes) within cloud computing platform 710. Node 730 is allocated to run one or more portions of a service application of a tenant. A tenant can refer to a customer utilizing resources of cloud computing platform 710. Service application components of cloud computing platform 710 that support a particular tenant can be referred to as a multi-tenant infrastructure or tenancy. The terms service application, application, or service are used interchangeably herein and broadly refer to any software, or portions of software, that run on top of, or access storage and compute device locations within, a datacenter.

When more than one separate service application is being supported by nodes 730, nodes 730 may be partitioned into virtual machines (e.g., virtual machine 752 and virtual machine 754). Physical machines can also concurrently run separate service applications. The virtual machines or physical machines can be configured as individualized computing environments that are supported by resources 760 (e.g., hardware resources and software resources) in cloud computing platform 710. It is contemplated that resources can be configured for specific service applications. Further, each service application may be divided into functional portions such that each functional portion is able to run on a separate virtual machine. In cloud computing platform 710, multiple servers may be used to run service applications and perform data storage operations in a cluster. In particular, the servers may perform data operations independently but exposed as a single device referred to as a cluster. Each server in the cluster can be implemented as a node.

Client device 780 may be linked to a service application in cloud computing platform 710. Client device 780 may be any type of computing device, which may correspond to computing device 700 described with reference to FIG. 7, for example, client device 780 can be configured to issue commands to cloud computing platform 710. In embodiments, client device 780 may communicate with service applications through a virtual Internet Protocol (IP) and load balancer or other means that direct communication requests to designated endpoints in cloud computing platform 710. The components of cloud computing platform 710 may communicate with each other over a network (not shown), which may include, without limitation, one or more local area networks (LANs) and/or wide area networks (WANs).

### Example Computing Environment

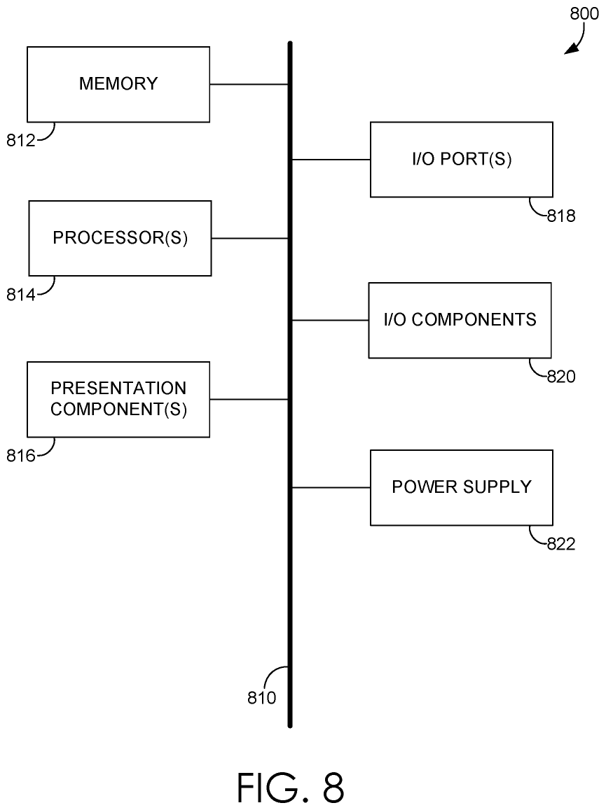

Having briefly described an overview of embodiments of the present invention, an example operating environment in which embodiments of the present invention may be implemented is described below in order to provide a general context for various aspects of the present invention. Referring initially to FIG. 8 in particular, an example operating environment for implementing embodiments of the present invention is shown and designated generally as computing device 800. Computing device 800 is but one example of a suitable computing environment and is not intended to suggest any limitation as to the scope of use or functionality of the invention. Neither should computing device 800 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc. refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 8, computing device 800 includes bus 810 that directly or indirectly couples the following devices: memory 812, one or more processors 814, one or more presentation components 816, input/output ports 818, input/output components 820, and illustrative power supply 822. Bus 810 represents what may be one or more buses (such as an address bus, data bus, or combination thereof). The various blocks of FIG. 8 are shown with lines for the sake of conceptual clarity, and other arrangements of the described components and/or component functionality are also contemplated. For example, one may consider a presentation component such as a display device to be an I/O component. Also, processors have memory. We recognize that such is the nature of the art, and reiterate that the diagram of FIG. 8 is merely illustrative of an example computing device that can be used in connection with one or more embodiments of the present invention. Distinction is not made between such categories as “workstation,” “server,” “laptop,” “hand-held device,” etc., as all are contemplated within the scope of FIG. 8 and reference to “computing device.”

Computing device 800 typically includes a variety of computer-readable media. Computer-readable media can be any available media that can be accessed by computing device 800 and includes both volatile and nonvolatile media, removable and non-removable media. By way of example, and not limitation, computer-readable media may comprise computer storage media and communication media.

Computer storage media include volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 800. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 812 includes computer storage media in the form of volatile and/or nonvolatile memory. The memory may be removable, non-removable, or a combination thereof. Exemplary hardware devices include solid-state memory, hard drives, optical-disc drives, etc. Computing device 800 includes one or more processors that read data from various entities such as memory 812 or I/O components 820. Presentation component(s) 816 present data indications to a user or other device. Exemplary presentation components include a display device, speaker, printing component, vibrating component, etc.

I/O ports 818 allow computing device 800 to be logically coupled to other devices including I/O components 820, some of which may be built in. Illustrative components include a microphone, joystick, game pad, satellite dish, scanner, printer, wireless device, etc.

### Additional Structural and Functional Features of Embodiments of the Technical Solution

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described in the paragraphs below may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present invention are described with reference to a distributed computing environment; however the distributed computing environment depicted herein is merely exemplary. Components can be configured for performing novel aspects of embodiments, where the term “configured for” can refer to “programmed to” perform particular tasks or implement particular abstract data types using code. Further, while embodiments of the present invention may generally refer to the technical solution environment and the schematics described herein, it is understood that the techniques described may be extended to other implementation contexts.

Embodiments of the present invention have been described in relation to particular embodiments which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects hereinabove set forth together with other advantages which are obvious and which are inherent to the structure.

It will be understood that certain features and sub-combinations are of utility and may be employed without reference to other features or sub-combinations. This is contemplated by and is within the scope of the claims.

What is claimed is:

1. A computerized system comprising:
one or more computer processors; and
computer memory storing computer-useable instructions that, when used by the one or more computer processors, cause the one or more computer processors to perform operations, the operations comprising:
accessing a request to perform a hybrid asset management operation for a digital asset;
accessing digital asset listing data of the digital asset from a blockchain system, wherein the digital asset listing data comprises non-fungible token (“NFT”) information for the digital asset;
based on the digital asset listing data, identifying a physical asset associated with the digital asset listing data, wherein the physical asset is associated with physical asset listing data; and
executing the hybrid asset management operation, wherein executing the hybrid asset management operation comprises causing display of the digital asset listing data for the digital asset and causing display of the physical asset listing data for the physical asset.

2. The system of claim 1, wherein the hybrid asset management operation is associated with a hybrid asset management service of an item listing platform that integrates management of physical assets and digital assets, wherein the hybrid asset management service further supports integrating an external NFT marketplace, an external crypto wallet, and an external blockchain system with the item listing platform of the hybrid asset management service.

3. The system of claim 1, wherein the blockchain system is a public blockchain system associated with a third-party blockchain system provider, the blockchain system is associated with a plurality of NFT marketplaces.

4. The system of claim 1, wherein accessing the digital asset listing data comprises mapping digital asset data from the blockchain system to an item listing data framework of the item listing platform.

5. The system of claim 1, wherein the physical asset is a twinned physical asset associated with the digital asset.

6. The system of claim 1, wherein the physical asset is a recommended physical asset from the item listing platform that is associated with the digital asset.

7. The system of claim 1, wherein executing the hybrid asset management operation further comprises automatically generating a hybrid physical-digital asset listing associated with the item listing platform, wherein the hybrid physical-digital asset listing comprises a physical-asset-listing interface portion and a digital-asset-listing portion.

8. The system of claim 1, wherein executing the hybrid asset management operation further comprises communicating a notification to cause transfer ownership of the physical asset based on an external location or an internal location associated with a physical storage vault associated with the physical asset.

9. The system of claim 1, wherein executing the hybrid asset management operation further comprises generating a hybrid asset management interface comprising and hybrid asset management data based on the physical asset listing data and the digital asset listing data.

10. The system of claim 9, wherein the hybrid asset management interface comprises a dashboard listing of physical assets and digital assets associated with a user account, wherein the hybrid asset management data is generated based at least in part on the user account.

11. One or more computer-storage media having computer-executable instructions embodied thereon that, when executed by a computing system having a processor and memory, cause the processor to perform operations, the operations comprising:
accessing a request to perform a hybrid asset management operation for a digital asset;
accessing digital asset listing data of the digital asset from a blockchain system, wherein the digital asset listing data comprises non-fungible token (“NFT”) information for the digital asset;
based on the digital asset listing data, identifying a physical asset associated with the digital asset listing data, wherein the physical asset is associated with physical asset listing data; and
executing the hybrid asset management operation, wherein executing the hybrid asset management operation comprises causing display of the digital asset listing data for the digital asset and causing display of the physical asset listing data for the physical asset.

12. The media of claim 11, wherein accessing the digital asset listing data comprises mapping digital asset data from the blockchain system to an item listing data framework of the item listing platform.

13. The media of claim 11, wherein the physical asset is a twinned physical asset associated with the digital asset or wherein the physical asset is a recommended physical asset from the item listing platform that is associated with the digital asset.

14. The media of claim 11, wherein executing the hybrid asset management operation further comprises automatically generating a hybrid physical-digital asset listing associated with the item listing platform, wherein the hybrid physical-digital asset listing comprises a physical-asset-listing interface portion and a digital-asset-listing portion.

15. The media of claim 11, wherein executing the hybrid asset management operation further comprises generating a hybrid asset management interface comprising and hybrid asset management data based on the physical asset listing data and digital asset listing data, wherein the hybrid asset management interface comprises a dashboard listing of physical assets and digital assets associated with a user account, wherein the hybrid asset management data is generated based at least in part on the user account.

16. A computer-implemented method, the method comprising:
accessing a request to perform a hybrid asset management operation for a digital asset;
accessing digital asset listing data of the digital asset from a blockchain system, wherein the digital asset listing data comprises non-fungible token (“NFT”) information for the digital asset;
based on the digital asset listing data, identifying a physical asset associated with the digital asset listing data, wherein the physical asset is associated with physical asset listing data; and
executing the hybrid asset management operation, wherein executing the hybrid asset management operation comprises causing display of the digital asset listing data for the digital asset and causing display of the physical asset listing data for the physical asset.

17. The method of claim 16, wherein accessing the digital asset listing data comprises mapping digital asset data from the blockchain system to an item listing data framework of the item listing platform.

18. The method of claim 16, wherein the physical asset is a twinned physical asset associated with the digital asset or wherein the physical asset is a recommended physical asset from the item listing platform that is associated with the digital asset.

19. The method of claim 16, wherein executing the hybrid asset management operation further comprises automatically generating a hybrid physical-digital asset listing associated with the item listing platform, wherein the hybrid physical-digital asset listing comprises a physical-asset-listing interface portion and a digital-asset-listing portion.

20. The method of claim 16, wherein executing the hybrid asset management operation further comprises generating a hybrid asset management interface comprising and hybrid asset management data based on the physical asset listing data and the digital asset listing data, wherein the hybrid asset management interface comprises a dashboard listing of physical assets and digital assets associated with a user account, wherein the hybrid asset management data is generated based at least in part on the user account.
